(19) United States
(12) Patent Application Publication
(10) Pub. No.: US 2004/0129248 A1
(43) Pub. Date: Jul. 8, 2004

(54) Throttle devices

(75) Inventor: Shinji Kawai, Aichi-ken (JP)

Correspondence Address: Ira J. Schultz, DENNISON, SCHULTZ & DOUGHERTY, Suite 612, 1745 Jefferson Davis Highway, Arlington, VA, 22202, US

(73) Assignee: Aisan Kogyo Kabushiki Kaisha

(21) Appl. No.: 10/742,191

(22) Filed: Dec. 22, 2003

(30) Foreign Application Priority Data
Dec. 25, 2002 (JP) 2002-375364

(51) Int. Cl. F02D 9/10; F16K 1/22

(52) U.S. Cl. 123/337; 251/305

(57) ABSTRACT

A throttle device includes a throttle body and a throttle valve disposed within a bore defined in the throttle body. Intake air may flow through the bore. The bore includes a main region, a first region, and a second region. The main region defines a first cross sectional area and opposes to the outer periphery of the throttle valve when the throttle valve is in the fully closed position. The first and second regions are respectively disposed on an upstream side and a downstream side of the main region. The first and/or the second regions may have a cross sectional area that is greater than the main cross sectional area. The difference in respective cross sectional areas allows for an increase in the response of intake airflow to the operational position of an accelerator.

This application claims priority to Japanese patent application serial number 2002-375364, the contents of which are incorporated herein by reference.

### BACKGROUND OF THE INVENTION

1. Technical Field

The present invention relates to throttle devices that are adapted to control the flow rate of intake air supplied to internal combustion engines.

2. Description of the Related Art

A known throttle device is shown in FIG. 8 and includes a throttle body 10 that defines a bore 12, through which intake air flows. A throttle shaft 20 extends across the bore 12 and is rotatably supported by the throttle body 10. A butterfly-type throttle valve 22 is secured to the throttle shaft 20, so that the throttle valve 22 opens and closes the bore 12 in response to the incremental rotation of the throttle shaft 20. In a fully closed position, the throttle valve 22 extends substantially perpendicular to an axis 12L of the bore 12 as indicated by solid lines in FIG. 8. More specifically, the throttle valve 22 has central plane 22C that includes the axis of the throttle shaft 20. In the fully closed position, the central plane 22C extends substantially perpendicular to the axis 12L of the bore 12.

A return spring (not shown) biases the throttle valve 20 in a direction towards the fully closed position (a direction indicated by an arrow YS in FIG. 8). A stopper (not shown) serves to prevent the throttle valve 22 from rotating beyond the fully closed position. In addition, the throttle shaft 20 may be rotated in an open direction (a direction indicated by an arrow YO in FIG. 8) against the biasing force of the return spring, the rotation corresponding to the depression of an accelerator, e.g., an accelerator pedal of an automobile. This type of known throttle device is disclosed in Japanese Laid-Open Patent Publication No. 9-4473.

An inner wall 12a of the bore 12 of the known throttle device has a cylindrical configuration that has a uniform diameter about the axis 12L throughout the length in the axial direction. Therefore, it is likely that the flow rate of the intake air is not very responsive to the change of a degree of opening (angle of rotation) of the throttle valve 22. The flow rate of intake air for the known device can be approximated by line L34 in FIG. 3. The graph of FIG. 3 illustrates various relationships between the degree of opening of a throttle valve and the flow rate of intake air for the known device and embodiments to be explained later. As shown in FIG. 3, there has been a problem with the known throttle device in that the intake airflow rate does not quickly change in response to the operation of the accelerator.

### SUMMARY OF THE INVENTION

It is accordingly an object of the present invention to teach techniques for improving the response of the rate of change of the flow rate of intake air caused by the movement of the throttle valve when an accelerator is operated.

According to one aspect of the present teachings, throttle devices are taught that include a throttle body and a throttle valve disposed within a bore defined within the throttle body. Intake air may flow through the bore. The throttle valve is rotatable between a fully closed position where the throttle valve extends substantially perpendicular to an axis of the bore, and an open position that is displaced from the fully closed position or a position substantially proximal to the fully closed position. The bore includes a main region, a first region, and a second region. The main region defines a first cross sectional area and opposes to the outer periphery of the throttle valve when the throttle valve is in a substantially fully closed position. The first and second regions are respectively disposed on an upstream side and a downstream side of the main region and opposite to the outer periphery of the throttle valve when the throttle valve is in the fully open position. At least one of the first and second regions has a second cross sectional area that is greater than the first cross sectional area. Thus, the enlarged portion may be provided on one of the first and second regions or on each of the first and second regions.

Therefore, when the throttle valve rotates from the fully closed position to the open position, there is an increase in the sectional area of the bore that defines a gap between the throttle valve and the inner wall of the bore allowing the flow rate of the intake air rapidly rise. Therefore, the flow rate of the intake air quickly changes in response to the operation of an accelerator, e.g., depressing an acceleration pedal of an automobile.

Preferably, the throttle valve extends substantially perpendicular to the bore axis when the throttle valve is in the fully closed position.

The enlarged portion may extend in a circumferential direction substantially half way or entirely around at least one of the first and second regions.

In a further aspect of the present teachings, the main region has an inner wall that has a substantially circular configuration with a first radius rotated about an axis of the bore to define the first cross sectional area. The enlarged portion has a substantially semi-circular inner wall that has a radius approximately the same length as the first radius but rotated about a radius starting point displaced away from the axis of the bore. The remaining portion of the at least one of the first and second regions has a substantially semi-circular inner wall with a radius equal to the first radius and the radius rotated about the axis of the bore.

Because the inner wall of the enlarged portion has a substantially semi-circular configuration with approximately the same radius as the first radius but rotated about a radius starting point displaced away from the axis of the bore, the enlarged portion has a relatively simple configuration and may be easily formed.

In a further aspect of the present teachings, the bore further includes an oblique wall region that has an inclined wall for gradually connecting the inner wall of the enlarged portion to the inner wall of the main region. The inclined wall is inclined relative to the bore axis. For example, the inclined wall may be inclined relative to the bore axis by a desired angle.

Through the use of the oblique wall regions, the intake air may smoothly flow from the first region with the enlarged portion to the main region or smoothly flow from the main region to the second region with the enlarged portion. As a result, resistance against the flow of the intake air can be reduced or minimized. In addition, the characteristics of the flow rate can be easily changed or adjusted at relatively low costs by changing the inclination angle of the inclined wall of the oblique wall region.

In a further aspect of the present teachings, the main region has an inner wall that has a substantially circular configuration with a first radius rotated about an axis of the bore to provide the first cross sectional area. The enlarged portion has an inner wall that has a substantially circular configuration with a second radius rotated about the bore axis. The second radius is greater than the first radius.

Therefore, the inner wall of the enlarged portion has a substantially circular configuration using the same radius starting point as with the main region. As a result, the enlarged portion of this embodiment also has a relatively simple construction and may be easily formed.

In another aspect of the present teachings, the bore further includes a tapered connecting region disposed between the main region and the at least one of the first and second regions. The connecting region has an inner wall that is inclined relative to the bore axis.

### BRIEF DESCRIPTION OF THE DRAWINGS

Additional objects, features and advantages of the present invention will be readily understood after reading the following detailed description together with the claims and the accompanying drawings, in which:

FIG. 1 is a vertical sectional view of a first representative throttle device; and

FIG. 2 is a horizontal sectional view of a bore of a throttle body of the first representative throttle device; and

FIG. 3 is a graph showing a relationship between a degree of opening of a throttle valve and an amount of the flow of intake air; and

FIG. 4 is a vertical sectional view of a second representative throttle device; and

FIG. 5 is a horizontal sectional view of a bore of a throttle body of the second representative throttle device; and

FIG. 6 is a vertical sectional view of a third representative throttle device; and

FIG. 7 is a horizontal sectional view of a bore of a throttle body of the third representative throttle device; and

FIG. 8 is a vertical sectional view of a known throttle device.

### DETAILED DESCRIPTION OF THE INVENTION

Each of the additional features and teachings disclosed above and below may be utilized separately or in conjunction with other features and teachings to provide improved throttle devices and methods of manufacturing and using such throttle devices. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

First Representative Embodiment

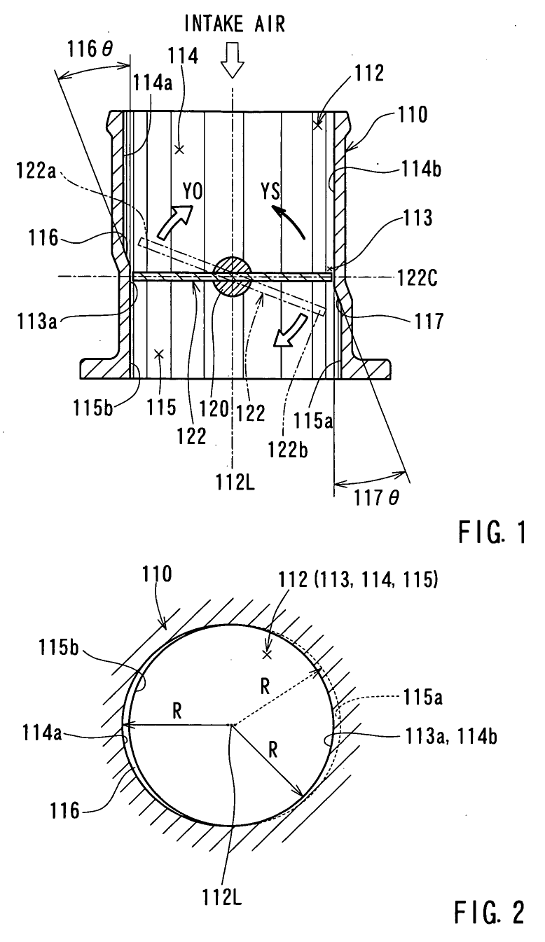

A first representative embodiment will now be described with reference to FIGS. 1 and 2. Referring to FIG. 1, a representative throttle device is adapted to supply intake air to an internal combustion engine (not shown) of a vehicle, e.g., an automobile. The representative throttle device includes a throttle body 110 that defines a bore 112 through which the intake air flows. A throttle shaft 120 extends across the bore 112 and is rotatably supported by the throttle body 110. A butterfly-type throttle valve 122 is secured to the throttle shaft 120 and has a substantially circular disk-shaped configuration. Therefore, the bore 112 may be incrementally closed and opened by the throttle valve 122 in response to the angle of rotation of the throttle shaft 120. The throttle valve 122 is positioned to be perpendicular to a main axis 112L of the bore 112 when the throttle valve 122 is in a fully closed position, as indicated by solid lines in FIG. 1. More specifically, the throttle valve 122 has a central plane 122C that includes the axis of the throttle shaft 120. In the fully closed position, the central plane 122C extends perpendicular to the main axis 112L of the bore 112. Also in the fully closed position, a small gap may be formed between an inner wall 113a of the bore 112 and the outer periphery of the throttle valve 122.

A return spring (not shown) biases the throttle valve 120 in a direction towards the fully closed position (a direction indicated by an arrow YS in FIG. 1). A stopper (not shown) serves to prevent the throttle valve 122 from rotating beyond the fully closed position. In addition, the throttle shaft 120 may be rotated in an open direction (a direction indicated by the YO arrow in FIG. 1) against the biasing force of the return spring. This rotation commonly takes place via a mechanical coupling mechanism or an electric drive mechanism in response to the amount of depression of an accelerator, e.g., in one example, an accelerator pedal of an automobile.

As shown in FIG. 1, the bore 112 includes a main cylindrical region 113. The bore 112 also includes a first enlarged portion 114 and a second enlarged portion 115 respectively disposed on the upstream side and the downstream side of the main cylindrical region 113. The main cylindrical region 113 defines an inner wall 113a that opposes the outer periphery of the throttle valve 122 when the throttle valve 122 is in a fully closed position or in a position substantially fully closed. The first enlarged portion 114 defines an inner wall including inner wall halves 114a and 114b. The inner wall half 114a opposes the outer periphery of an upstream side half 122a of the throttle valve 122 when the throttle valve 122 is opened to beyond a small angle from the fully closed position. In addition, the first enlarged portion 114 has a cross sectional area that is larger than the cross sectional area of the main cylindrical region 113. The second enlarged portion 115 defines an inner wall including inner wall halves 115a and 115b. The inner wall half 115a opposes the outer periphery of a downstream side half 122b of the throttle valve 122 when the throttle valve 122 is opened beyond a small angle from the fully closed position. Also, the second enlarged portion 115 has a cross sectional area that is greater than the cross sectional area of the main cylindrical region 113.

Referring to FIG. 1, the inner wall 113a of the main cylindrical region 113 has a circular cross section and has a radius R (see FIG. 2) about the main axis 112L of the bore 112.

The inner wall half 114a of the first enlarged portion 114, adapted to oppose to the upstream-side half 122a of the throttle valve 122, has a radius approximately equal to the radius R of the main cylindrical region 113. However, the starting point of the radius of the inner wall half 114a is displaced to the left of the main axis 112L by a small distance as viewed in FIGS. 1 and 2. However, the remaining inner wall half 114b has a radius that is equal to the radius of the inner wall 113a of the main cylindrical region 113. The starting point of the radius of the inner wall half 114b is coincident with the main axis 112L.

The inner wall half 115a of the second enlarged portion 115, adapted to oppose to the downstream side half 122b of the throttle valve 122, has a radius that is substantially equal to the radius R of the main cylindrical region 113. However, the starting point of the radius of the inner wall half 115a is displaced by a slight distance to the right of the main axis 112L, as viewed in FIGS. 1 and 2. The slight distance is approximately equal to the distance of the displacement of the starting point of the radius of the inner wall half 114a from the main central axis 112L. On the other hand, the remaining inner wall half 115b has a radius that is equal to the radius of the inner wall 113a of the main cylindrical region 113. The starting point of the radius of the inner wall half 115b is coincident with the main central axis 112L.

Referring to again FIG. 1, the inner wall half 114a of the first enlarged portion 114 is connected to the corresponding inner wall half of the inner wall 113a of the main cylindrical region 113 via an oblique cylindrical wall half 116. The wall half 116 is offset relative to the main axis 112L by an angle of 116 θ. The angle of 116θ shown in FIG. 1 may be 20° for example.

On the other hand the inner wall half 115a of the second enlarged portion 115 is connected to the corresponding inner wall half of the inner wall 113a of the main cylindrical region 113 via an oblique cylindrical wall half 117. The wall half 117 is inclined relative to the main axis 112L by an angle of 117 θ. The angle of 117 θ may be the same as the angle of 116 θ, for example 20°, but the two angles are not required to be equivalent.

According to the first representative throttle device, when the throttle valve 122 is in the fully closed position or during an idling operation of the internal combustion engine, the flow rate of intake air that flows through the bore 112 is largely determined by gaps formed between the inner wall 113a of the main cylindrical region 113 and the outer periphery of the throttle valve 122. Because the throttle valve 122 in the fully closed position extends approximately perpendicular to the main axis 112L of the bore 112, the possible variations in cross sectional areas of the gaps may be very small, even if the fully closed position has to be shifted by a small angle from the perpendicular position due to fluctuations of tolerance in manufacturing or assembling the throttle device. Therefore, variations in the flow rate for an idling internal combustion engine due to inaccurate set angles for the fully closed position of the throttle valve 122 can be reduced or minimized.

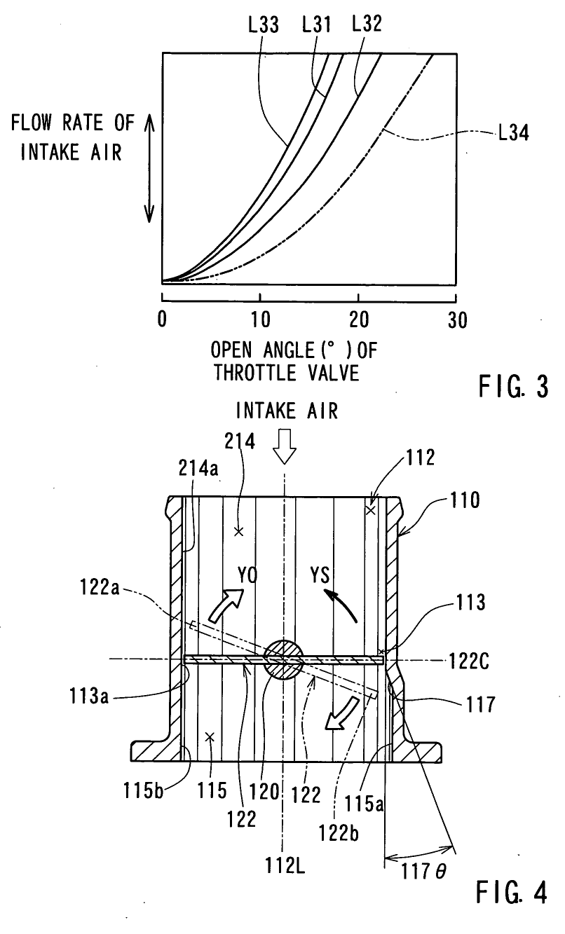

When the accelerator has been acted upon in order to open the throttle valve 122 from the fully closed position, i.e. preferably the substantially perpendicular position, to another position as indicated by ‘two-dotted’ chain lines shown in FIG. 1, the outer periphery of the upstream side half 122a and the outer periphery of the downstream side half 122b of the throttle valve 122 respectively oppose the first enlarged portion 114 and the second enlarged portion 115. As a result, the cross sectional areas of the gaps between the inner wall of the bore 112 and the outer periphery of the throttle valve 122 quickly increase, causing the flow rate of the intake air to also quickly increase. As shown in FIG. 3, a representative line L31, corresponding to the first representative throttle device, is indicative of the actual flow rate of the intake air as a function of the change in the opening angle degree of the throttle valve 122. The actual flow rate of the intake air rises quickly as the throttle valve opening angle increases from approximately 0° (fully closed position). As a result, the responsiveness of the rate of change of the flow rate of the intake air corresponding to the amount of accelerator operation can be improved.

In addition, according to the first representative embodiment the enlargement of the sectional areas of the first and second enlarged portions 114 and 115 is attained by a simple arrangement in which the inner wall halves 114a and 115a have the same radius as the radius R of the inner wall 113a of the main cylindrical region 113, but have radius starting points that are displaced away from the main central axis 112L of the bore 112. The main central axis 112L is the starting point of the radius R of the inner wall 113a (see FIG. 2). The resulting first and second enlarged portions 114 and 115 can be readily designed and easily manufactured (for example, by casting or machining).

Further, according to the first representative embodiment, the inner wall 113a of the main cylindrical region 113 is connected to the inner wall half 114a of the first or upstream-side enlarged portion 114 via an oblique wall 116. The arrangement allows the intake air to smoothly flow from the first enlarged portion 114 into the main cylindrical region 113. Also, the inner wall 113a of the main cylindrical region 113 is connected to the inner wall half 115a of the second or downstream-side enlarged portion 115 via an oblique wall 117. This arrangement also allows the intake air to smoothly flow from the main cylindrical region 113 into the second enlarged portion 115. As a result of this embodiment, resistance against the flow of the intake air can be reduced or minimized.

Furthermore, the characteristics of the flow of the intake air can be easily adjusted at relatively low costs by appropriately setting the inclination angles 116 θ and 117 θ of the oblique walls 116 and 117.

Second Representative Embodiment

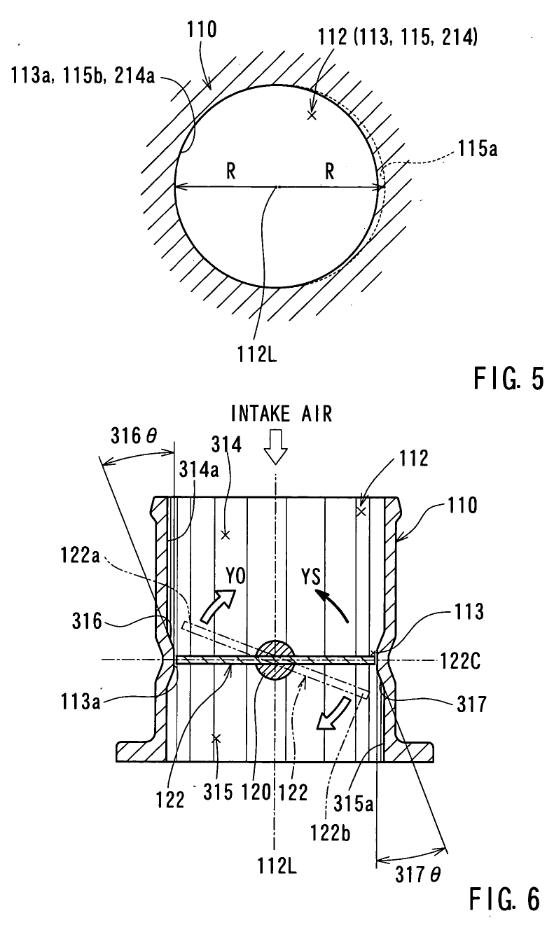

A second representative embodiment will now be described with reference to FIGS. 4 and 5 that show a second representative throttle device that is a modification of the first representative throttle device. In FIGS. 4 and 5, elements that are similar to or identical with the first representative throttle device are labeled with the same reference numerals and an explanation of these elements may not be repeated.

The second representative throttle device differs from the first representative throttle device essentially in that the first or upstream-side enlarged portion 114, including the oblique wall 116 of the bore 112, is replaced with a first or upstream region 214 that is configured as a straight bore region. More specifically, as shown in FIG. 5, the first region 214 has an inner wall 214a with essentially the same radius and starting point as the radius R of the inner wall 113a of the main cylindrical region. 113. The starting point for the radius of the first region 214 is positioned on the main axis 112L of the bore 112.

With the second representative embodiment, substantially the same operational characteristics and advantages as with the first representative embodiment can be attained. As shown in FIG. 3, a characteristic line L32, indicative of the flow rate of the intake air corresponding to a change in the opening degree of the throttle valve 122 of the second representative throttle device, rises quickly as the opening angle increases from an angle slightly greater than or equal to 0°. However, the rate of increase of the flow rate of intake air in the second representative embodiment is not as great as the rate of increase as in the first representative embodiment.

As an alternative of the second representative embodiment, the second or downstream side region and the first or upstream side region may be reverses. More specifically, the second or downstream-side region 115 including the oblique wall 117 of the bore 112 of the throttle body 110 may be replaced with a region (not shown) that is configured as a straight bore region. The second region may have an inner wall that has the same radius and starting point as the radius R of the inner wall 113a of the main cylindrical region 113. The starting point of the downstream radius may be positioned on the main axis 112L of the bore 112. The first or upstream side region 114 may be enlarged as previously presented in the first embodiment.

Third Representative Embodiment

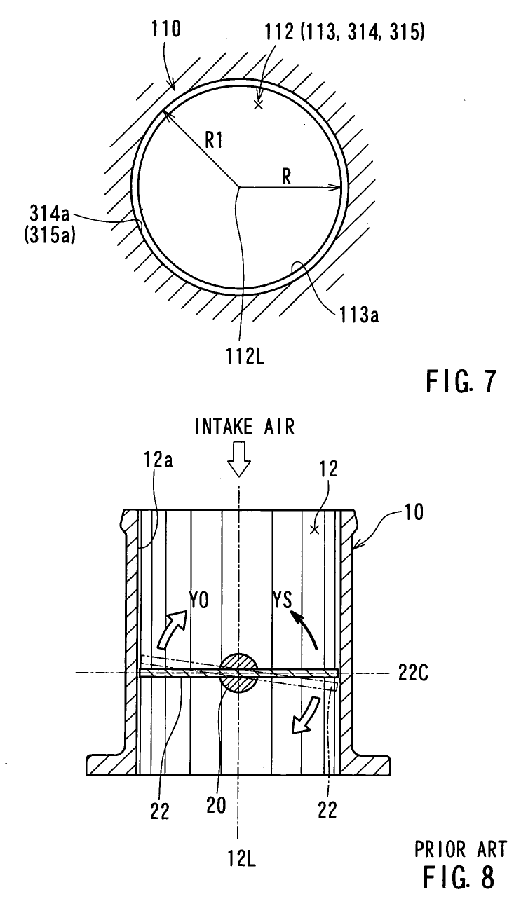

A third representative embodiment will now be described with reference to FIGS. 6 and 7 that show a representative throttle device that is a modification of the first representative throttle device. In FIGS. 6 and 7, elements that are similar to or identical with the first representative throttle device are labeled with the same reference numerals and an explanation of these elements will may not be repeated.

As shown in FIG. 6, a first or upstream side enlarged portion 314 and a second or downstream side enlarged portion 315 of the bore 112 have inner walls 314a and 315a, both having a radius R1 with a radius starting point on the main axis 112L. As shown in FIG. 7, the radius R1 is slightly greater than the radius R of the inner wall 113a of the main cylindrical region 113.

In addition, the inner wall 314a of the first enlarged portion 314 is connected to the main cylindrical region 113 via a tapered or a truncated conical wall 316 that is inclined relative to the main axis 112L by an angle 316 θ. Similarly, the inner wall 315a of the second enlarged portion 314 is connected to the main cylindrical region 113 via a tapered or a truncated conical wall 317 that is inclined relative to the main axis 112L by an angle 317 θ Preferably, the angles 316 θ and 317 θ are both equal to each other and are approximately 20°.

The third representative embodiment also attains substantially the same operational characteristics and advantages as with the first representative embodiment. As shown in FIG. 3, a characteristic line L33 indicative of the flow rate of the intake air corresponding to a change in the opening degree of the throttle valve 122 of the third representative throttle device, rises quickly as the opening angle increases from slightly greater than or equal to 0°. In addition, the overall rate of increase of the flow rate of intake air in the third representative embodiment is higher than the rate of increase in the first representative embodiment.

Further, the first and second enlarged portions 314 and 315 can be easily manufactured due to the simple circular cross sections of the inner walls 314a and 315a and radius starting points positioned on the main axis 112L.

Furthermore, because the inner wall 314a of the first or upstream side enlarged portion 314 of the bore 112 is connected to the inner wall 113a of the main cylindrical region 113 via the tapered wall 316, the intake air may smoothly flow from the first enlarged portion 314 into the main cylindrical region 113. Similarly, because the inner wall 315a of the second or downstream side enlarged portion 315 is connected to the inner wall 113a of the main cylindrical region 113 via the tapered wall 317, the intake air may also smoothly flow from the main cylindrical region 113 into the second enlarged portion 315. As a result, the resistance against flow of the intake air may be reduced or minimized.

Furthermore, the flow characteristics of the intake air can be easily adjusted at relatively low costs by appropriately setting the inclination angles 316 θ and 317 θ of the tapered walls 316 and 317.

The above third representative embodiment may be modified such that one of the first enlarged portions 314 (including the tapered wall 316) and the second enlarged portion 315 (including the tapered wall 317) is replaced with a straight cylindrical region, having an inner wall with a radius and starting point equal to the radius R of the inner wall 113a of the main cylindrical region 113. The radius starting point of the replaced region may be on the main axis 112L of the bore 112.

The above representative embodiments may be further modified in various ways within the scope of the invention defined by the appended claims. For example, although the throttle valve 122 and the bore 112 of the throttle body 110 in the above representative embodiments are shown with circular or substantially circular configurations, other geometric shapes may be used (e.g. square, polygonal, or elliptical configurations for example).

What is claimed is:

1. A throttle device comprising:
a throttle body defining a bore; and
a throttle valve disposed within the bore; wherein:
the throttle valve is rotatable between a fully closed position substantially perpendicular to an axis of the bore, and an open position that is displaced from the fully closed position;
the bore includes a main region, a first region, and a second region;
the main region defines a first cross sectional area and opposes the outer periphery of the throttle valve when the throttle valve is in the fully closed position or the position proximate to the fully closed position;
the first and second regions are respectively disposed on opposing sides of the main region along the axis of the bore;
at least one of the first and second regions has a second cross sectional area that is greater than the first cross sectional area.

2. A throttle device as in claim 1, wherein the at least one of the first and second regions has an enlarged portion that extends substantially half of the at least one of the first and second regions in a circumferential direction.

3. A throttle device as in claim 2, wherein the main region has an inner wall that has a substantially circular configuration with a first radius about the axis of the bore to define the first cross sectional area, the enlarged portion has an inner wall that has a substantially semi-circular configuration defined by substantially the same radius as the first radius rotated about a radius starting point displaced from the axis of the bore, and the remaining portion of the at least one of the first and second regions has an inner wall that has a substantially semi-circular configuration defined by the same radius as the first radius rotated about the axis of the bore.

4. A throttle device as in claim 3, wherein the bore further includes a connecting region having an inner wall for connecting between the inner wall of the enlarged portion to the inner wall of the main region, and the inner wall of the connecting region is inclined relative to the bore axis by an angle.

5. A throttle device as in claim 4, wherein the enlarged portion is provided for both of the first and second regions.

6. A throttle device as in claim 5, wherein the connecting region is disposed between the main region and both of the first and second regions.

7. A throttle device as in claim 1, wherein the at least one of the first and second regions has an enlarged portion that extends substantially entirely about the at least one of the first and second regions in a circumferential direction.

8. A throttle device as in claim 7, wherein:
the main region has an inner wall that has a substantially circular configuration with a first radius rotated about the bore axis to define the first cross sectional area;
the enlarged portion has an inner wall that has a substantially circular configuration with a second radius rotated about the bore axis; and
the second radius is greater than the first radius.

9. A throttle device as in claim 8, wherein the bore further includes a tapered connecting region disposed between the main region, and the at least one of the first and second regions, and the connecting region has an inner wall inclined relative to the bore axis.

10. A throttle device as in claim 9, wherein the enlarged portion is provided for both of the first and second regions.

11. A throttle device as in claim 10, wherein the tapered connecting region is disposed between the main region and both of the first and second regions.

12. A throttle device comprising:
a throttle body defining a bore, wherein intake air flows through the bore; and
a throttle valve disposed within the bore; wherein:
the throttle valve is rotatable between a fully closed position where the throttle valve extends substantially perpendicular to an axis of the bore, and an open position that is displaced from the fully closed position;
the bore includes a main region, a first region, and a second region;
the main region defines a first cross sectional area and opposes the outer periphery of the throttle valve when the throttle valve is in the fully closed position or the position proximate to the fully closed position;
the first and second regions are respectively disposed on an upstream side and a downstream side of the main region, and oppose to the outer periphery of the throttle valve when the throttle valve is in the open position;
at least one of the first and second regions has a second cross sectional area that is greater than the first cross sectional area.

13. A throttle device as in claim 12, further including a throttle shaft extending across the bore and rotatably supported by the throttle body, wherein the throttle valve is mounted to the throttle shaft, the throttle valve includes an upstream side rotating into the first region of the bore during the opening of the throttle valve and a down stream side rotating into the second region of the bore during the opening of the throttle valve..

14. A throttle device as in claim 13, wherein the throttle valve is coupled to an accelerator of an automobile, so that the throttle valve rotates by an angle corresponding to an amount of operation of the accelerator.

15. A throttle device as in claim 14, wherein the first region has an enlarged portion and the second region has an enlarged portion, the enlarge portions extend substantially half of the at least one of the first and second regions in a circumferential direction, wherein the enlarged portions are located to be opposed to the upstream side and the downstream side of the throttle valve during the opening of the throttle valve.
